(19) United States
(12) Patent Application Publication
(10) Pub. No.: US 2004/0219271 A1
(43) Pub. Date: Nov. 4, 2004

(54) Molded bread products and process for making

(76) Inventors: Larry Belknap, Maple Grove, MN (US); Jimmy A. Demars, Hugo, MN (US); James S. Thorson, Scandia, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/427,754

(22) Filed: May 1, 2003

(51) Int. Cl. A21D 10/00

(52) U.S. Cl. 426/549

(57) ABSTRACT

Uniquely shaped baked bread dough products may be made by a continuous extrusion and molding process. The shaped baked bread dough product optionally may additionally be provided with a filling. Shaped bread products preferably have a precision reproducible shape comprising flat and/or curvilinear surfaces corresponding to the shape of a mold, wherein all exposed surfaces of two such bread products are the same in dimension and without visible flaw. The products preferably are uniform in density. In another aspect of the present invention, food products are provided with surprisingly complex shape features that are unexpected in bread products.

### FIELD OF THE INVENTION

The invention relates to dough products that optionally contain a filling. More specifically, the invention relates to a shaped dough product optionally containing a filling.

### BACKGROUND

Baked products having particular shapes are known in the art for the purpose of attracting the interest of a consumer or for use in combination with moist components in order to enable the consumption of the combined food product without utensils. Thus, it is known to provide crackers with decorative indicia, such as the name of the product displayed on the surface of the cracker. Also, bread has been provided in the shape of a bowl in order to be used as a recess for soup or a salad.

U.S. Pat. No. 3,290,154 to Turner discloses an edible baked cup-shaped product and method for making same. In this method, a ball of bread dough is placed in the bottom of a female mold cavity, and a cup-shaped male mold is inserted axially into the cavity to form a cup-shaped chamber for confining the dough. The resulting baked product is in the shape of a cup that has greater density at the bottom of the cup to resist the moistening effect of edible fillers. See column 6, lines 20-30. U.S. Pat. No. 4,205,091 to Van Horne discloses an edible server which is an elongated wafer formed with a series of cup-shaped recesses. The edible server is described to have a constituency similar to that of soda crackers, ice cream cones or various other baked, usually flour based food products. U.S. Pat. No. 3,888,997 to Guibert discloses a method and apparatus for processing dough, where a dough is formed which is mechanically worked, extruded, cut into dough balls and formed into shapes ready for baking.

U.S. Pat. No. 6,180,151 to Geng describes an extrusion process for leavened dough products. This patent describes coextruding the dough with a filling to form a filled tube or extruding the dough as a sheet that is subsequently wrapped around a filling (see column 5, lines 50-65).

### SUMMARY OF THE INVENTION

It has been found that unique shaped baked bread dough products may be made by a continuous extrusion and molding process. The resulting product exhibits excellent appearance with significant reduction in visible product surface flaws, even though the process for making the product is highly efficient in both speed and cost effectiveness. In a particularly preferred embodiment of the present invention, the shaped baked bread dough product is additionally provided with a filling. This product construction provides excellent convenience to the consumer. In certain formats, the product may be eaten without using utensils, and may additionally create less mess both in cooking and eating. The shaped product may be provided as a highly portable product construction on a very efficient basis. Certain particularly preferred formats provide a surprisingly high filler to bread ratio.

In a particularly preferred aspect of the present invention, a process is provided for forming shaped bread dough products. In this process, a dough composition is provided comprising flour, water, and a pre-gelatinized starch comprising at least about 75 percent of amylopectin. The dough composition is mixed and extruded under conditions so that the dough composition does not exceed 140° F. throughout the extrusion process. Bread doughs prepared in connection with the present invention have extensibility values ranging between about 170 and 240 mm.

The mixed dough is extruded into a shaped mold, thereby imparting a shape to the dough corresponding to the shape of the mold. The thusly-shaped dough is baked so that the baked shaped dough product has a bread-like texture and a BSV of greater than about 3.0 cc/g.

In a still further embodiment of the present invention, a molded, shaped dough product having a bread like texture is described and includes a base having an interior area and an exterior periphery and at least one wall extending substantially perpendicularly from the base and being positioned about the periphery. The wall based about the periphery has a height and a thickness. The baked product is provided with a plurality of cavities, each of cavities formed from at least an intersection of at least one longitudinally extending ridge and at least one transversely extending ridge with the peripheral wall. The transversely and longitudinally extending ridges extend substantially perpendicularly from the base and each of the plurality of cavities are capable of receiving a filling. Each of the transversely extending and longitudinally extending ridges have a top and bottom edge with the bottom edge of each wall being connected to the base. The longitudinally extending ridge and the transversely extending ridge have a height substantially equal to the height of the at least one wall extending about the periphery of the base. The shaped dough product of the present invention has as an extensibility ranging from 170 to 240 mm.

The present invention also provides shaped bread products having a precision reproducible shape comprising flat and/or curvilinear surfaces corresponding to the shape of a mold, wherein all exposed surfaces of two such bread products are the same in dimension and without visible flaw. The products preferably are uniform in density. In another aspect of the present invention, food products are provided with surprisingly complex shape features that are unexpected in bread products.

### BRIEF DESCRIPTION OF THE DRAWING

The accompanying drawings, which are incorporated in and constitute a part of this application, illustrate several aspects of the invention and together with a description of the embodiments serve to explain the principles of the invention. A brief description of the drawings is as follows:

FIG. 1 is a flowsheet form of a process of the present invention.

FIG. 2 is a flowsheet form of an alternative process of the present invention.

FIG. 3 shows a top view of a filled dough product of the present invention.

FIG. 4 is a side view of the product as shown in FIG. 3.

FIG. 5 shows a top view of a filled dough product of the present invention.

FIG. 6 is a side view of the product as shown in FIG. 5.

FIG. 7 is a perspective view of a filled dough product of the present invention.

FIG. 8 is a perspective view of a dough product of the present invention having a highly complex shape.

FIG. 9 is a perspective view of a dough product of the present invention, wherein recesses are provided having a cylindrical or cup-like shape.

FIG. 10 is a perspective view of a dough product having projections projecting from the floor of the dough product.

FIG. 11 is a cross section of the dough product 110 as shown in FIG. 10, taken along line 11-11.

### DETAILED DESCRIPTION

The food product of the present invention provides a unique product both in texture and appearance. Preferably, the product is a breakfast, lunch, dinner or snack comestible that is a food snack, appetizer, entree or dessert product. The product may be provided in a frozen or refrigerated state or alternatively may be sold as part of a “fresh bread” type product. The methods and apparatuses provide a more accurate rendition of the desired shapes of projections to extend from the surface of the food product, and additionally allow for a faster and more efficient production of the food product because this more accurate rendition is now achievable at higher extrusion rates. The resulting product preferably is uniform in texture and density due to selection of ingredients, methods and the processing apparatuses used.

The present invention may also be provided in various flavors such as sourdough, rye, wheat, multi-grain, pumpernickel and the like.

The phrase “organoleptic properties” as used herein is meant to indicate those properties, whether visual, textural or taste properties that contribute to the overall quality of a dough product. For example, organoleptic properties are typically meant to include such properties as taste, color, smell, texture, shape, appearance, mouthfeel, smoothness, and the like.

The term “baked specific volume” (“BSV”) is a term of art generally known in the industry to define the inverse of density or fluffiness of a baked good, and is simply the volume of the baked product divided by its weight. The determination of BSV is of course done only on the dough portion of the baked product, and does not include any filling, if present.

The term “extrusion” or “extruding” as used herein refers to a process of forcing a dough composition through an orifice under pressure of at least about 50 p.s.i., and typically from about 50 to about 150 p.s.i. and may be accomplished by extruding, mixing and pumping or combinations thereof.

Extensibility is the degree to which a dough product can be extended before it breaks. An extensigraph is a load-extension instrument that is designed to provide empirical measurements of the extensibility of the dough. Extensigraphs are commonly used for studying flour quality and the effect of certain additives on bread baking. One method of measuring the extensibility of a dough that has been mixed is to weigh the dough, mold it into a cylinder shape, and clamp it at both ends in a special cradle of the extensigraph machine. After an optional rest period, the dough is stretched using a hook that moves at a constant rate of speed. The dough is stretched, through its midpoint, and then until it ruptures or breaks.

The result of this test is a load (resistance) versus extension curve, commonly called an extensigram. Much useful information can be obtained from an extensigram. The measurements most commonly obtained from an extensigram are, the maximum resistance, Rₘ, which is determined by the maximum height of the curve, the resistance at an extension of about 5 cm, R₅, and the total curve length in centimeters (at what length the dough breaks). The R values of these measurements are generally given in arbitrary units of resistance called Brabender units. The total area under the curve is also often calculated and reported in square centimeters.

The maximum height of the curve, and the area under the curve are indicative of the strength of the dough. Larger values of the area or the maximum curve height indicate a stronger dough while smaller values indicate a weaker dough. The overall shape of an extensigram can give an estimate of the dough's viscoelastic balance, with long, low curves having a predominance of viscosity over elasticity.

The length that the dough stretches before it breaks is called the extensibility of the dough. Bread doughs prepared in connection with the present invention have extensibility values ranging from about 170 to about 240 mm.

One important characteristics of a baked product is the product's baked specific volume (“BSV”). The BSV of a product relates the volume of the baked product to the weight of the product. Generally, products with higher BSVs are lighter and have more gas or air incorporated therein. Products with lower BSVs are heavy, dense and generally undesirable in developed doughs.

BSV can be measured using commonplace displacement methods. One example of a method commonly used is the rapeseed method. In this method, a baked product of a known mass is placed in a container along with a known and measurable volume of rapeseed. Once the baked product is placed in the container containing the baked product, the volume of the rapeseed and baked product is measured. The specific volume of the baked product is then determined by dividing the volume of the baked product by the mass of the baked product.

Dough products, such as baked breads and rolls generally have improved BSVs. Improved BSVs can refer to higher values of BSV or similar values of BSV obtained with a shorter mixing time for the dough.

For purposes of the present invention, a dough composition and dough products made from a dough composition are distinguished from a batter composition and batter products made from a batter composition in that dough products are at least partially developed. A dough composition as for purposes of the present invention differs from a batter composition in that the dough composition prior to cooking exhibits elastic memory. Thus, an uncooked dough composition when stretched or compressed will at least partially recover its previous shape after removal of the stretching or compression force.

In a dough composition, the ability to retain the gases as part of the leavening process is provided by the interconnected structure of the gluten and proteins in the flour composition, which structure is generated during the work put into the dough system during mixing. This interconnected gluten structure may be observed microscopically, by utilizing a stain specific to gluten in a manner well known in the art. The physical property characteristics of the uncooked dough composition provide unique flavor and textural properties in the final product. In particular, the dough product has a cohesiveness unique to bread and breadlike products. Batter compositions, in contrast, are not developed, and therefore flow without exhibiting elastic memory. Microscopic evaluation of the batter composition will reveal isolated concentrations of gluten, without formation of the desired interconnected structure required to indicate dough development. Examples of batter products include cake mixes, pancakes, waffles and the like. These products are, in general, not as cohesive as dough products, and cannot achieve the same flavor characteristics. While cohesiveness may be imparted to batter products by formation of an interconnecting polymer network through incorporation of gums or polymers in the batter composition, flavor may be adversely affected, with the resulting texture of the batter product still not achieving the desired texture that can only be realized by a dough product as defined herein.

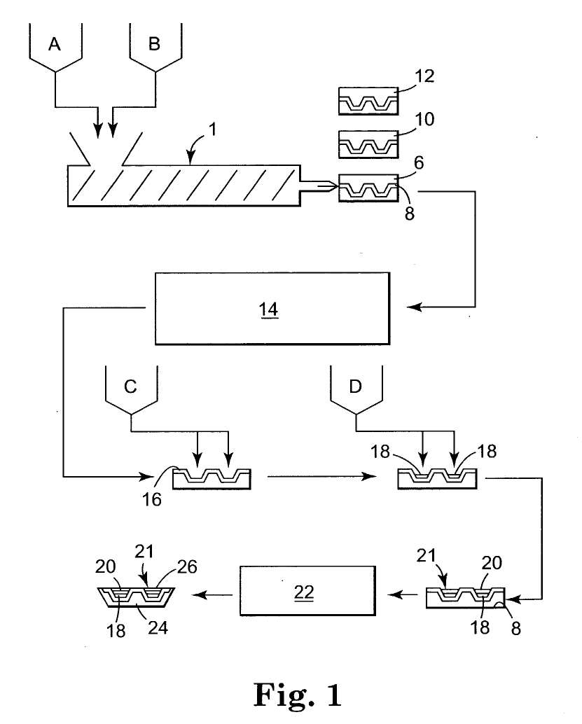

Turning now to the drawings, wherein like numbers represent like parts, FIG. 1 is a flowsheet form of a process of the present invention. Components of the dough composition are provided from one or more delivery vessels suitable to provide the components of the dough. As shown, first delivery vessel A provides a mixture of the dry components of the dough, and second delivery vessel B provides a mixture of wet and/or combinations of wet and dry components of the dough in the form of a slurry. As discussed in more detail below, the dough composition comprises pre-gelatinized starch comprising at least about 75 percent of amylopectin, and additionally comprises flour and water. Other dough components may additionally be added, as discussed below. These components are added to mixer/extruder 1 and mixed and extruded under conditions so that the dough composition does not exceed 140° F. The resulting dough prepared in connection with the present invention has extensibility values ranging between about 170 and 240 mm. While not being bound by theory, it is believed that the extrusion temperature cap is required to assure that any starches present in other ingredients of the dough composition, such as natural starches present in flour and like, do not gelatinize; and further that any proteins present in the composition do not denature. Maintenance of the dough at this desired temperature is preferably accomplished by ensuring that the temperature of the extruder does not exceed 140° F. Preferably, the dough is maintained at a temperature below about 120° F., and more preferably below about 100° F. As above, this temperature maximum is preferably achieved by maintenance of the temperature of the extruder and ingredients below the desired temperature of the dough.

The dough as described herein may be extruded using any appropriate extruder for extruding dough, provided that the extrusion is carried out a temperature below about 140° F. For example, conventional single screw food extruders may be used to extrude the present dough compositions. Alternatively, twin screw extruders may be used with the present dough compositions, provided that the twin screw extruder (which is normally used for heated extrusion) is capable of carrying out the extrusion as a temperature below about 140° F. Combination extruder devices, that utilize single screw and twin screw components, as well as dough pumps are also contemplated.

When combining the ingredients of the dough, the order of addition of ingredients is not critical. In one embodiment of the present invention, all ingredients are simultaneously added to the extruder and mixed in the extruder. This embodiment is particularly useful in providing a continuous process for extrusion of bread dough. Alternatively, various ingredients may be pre-combined to facilitate a continuous process or a batch process. For example, the dry ingredients may first be combined alone to create a “dry blend.” Dry blend ingredients include, but are not limited to flour, leavening agents, pre-gelatinized starch, salt, and sugars. Fat, which may be added as shortening or as oil, may optionally be added directly to the dry blend. A slurry portion may be separately pre-blended. The slurry portion may include, for example, water, protein, and surfactant. Any additional liquid ingredients or those ingredients containing moisture may also be added to the slurry portion. These additional slurry ingredients may include liquid sugars. Flavoring agents are generally added into the slurry portion of the composition. Alternatively, the flavoring agents may be added to the dry blend, particularly if they are substantially anhydrous. The slurry portion is added to the dry blend-oil combination and mixed until a dough is formed. Combining such ingredients is accomplished by any means commonly known in the baking industry. These include, for example, combining the ingredients in a stand mixer fitted with a dough hook or by combining the ingredients in a twin screw premixer.

The following mixing method is preferably employed. The dry blend ingredients are combined and added into a twin screw premixer. The slurry portion is then added into the premixer, followed by addition of the fat component of the dough. The ingredients are combined until gluten is barely hydrated. That is, mixing continues until the gluten has barely formed so as not to create tough or highly developed dough. The dough is then fed into an extruder, gas, such as nitrogen, is injected under pressure, a final mix occurs then the dough is pushed out of a selected die orifice that is suited for whatever type of product is being manufactured. As previously stated, the premixer and the extruder must remain at temperatures that do not allow the dough temperature to rise above 140° F.

FIG. 1 shows a flowsheet form of a process of the present invention. As shown, the dough extrusion composition is extruded as a continuous feed into mold 6 to fill mold cavity 8 with uncooked dough. Because of the dough viscosity, dough component selection and extrusion process parameters used in the method as described, the dough completely fills mold cavity 8 substantially without gaps that would lead to visible flaws in the final baked product. For purposes of the present invention, flaws are discontinuities in dough products due to incomplete filling of mold cavity 8 during the extrusion process. Visible flaws are evaluated by careful inspection at a distance of about 30 centimeters without magnification. Additionally, surprisingly because of the dough viscosity, dough component selection and extrusion process parameters used in the method as described, the dough is injected into mold cavity 8 under sufficiently low stress to provide a final bread product of uniform texture throughout the product, without imparting stresses that would disrupt the gluten matrix of the bread and lead to striations and other perceptible differences in texture from one portion of the bread product to the other. The complete distribution and relatively low stress injection of dough into the mold cavity 8 provides a product having a uniform density. Optionally, mold 6 may be preheated to initiate setting of the dough in the desired shape. Additional shaped molds 10 and 12 may be serially conveyed into place for filling by extruder 1 to provide a continuous process. For purposes of the present invention, the phrase a “continuous process” refers to a process that can be operated by supplying input materials and withdrawing output materials under substantially steady state conditions after start-up and prior to shutdown.

After filling with dough, shaped mold 6 is conveyed to oven 14 for baking. Baking temperature and dwell times of the product in the oven depend on the thickness of the molds that are used and the size and nature of the product to be baked, and may determined by trial and error or any appropriate manner. Optionally, the baked bread dough product could be removed from the mold at this stage and packaged for sale in an unfilled format. Preferably, the dough product is configured to provide at least one recess for receiving filling. One or more fillings are preferably provided. One embodiment of a method for providing a filling is shown in FIG. 1. Filling source C is provided to deposit filling 18 into baked dough portion 16. Optional topping source D is provided to deposit topping 20 on top of filling 18. The thus filled and topped baked bread dough product 21 is conveyed to packager 22, where mold 6 is replaced by package container 24 and package lid 26. Because the baked bread dough product must be removed from the mold in this embodiment, preferably the mold is treated with a mold release material to assist in removal of the baked bread dough product. The mold may alternatively or additionally be fabricated from a material that has release characteristics with respect to baked dough, such as a metal provided with a Teflon release coating thereon. Alternatively, mold 6 may be fabricated from a material suitable for use itself as a package container. In yet another alternative, mold 6 may be provided with a removable liner at the beginning of the extrusion process, which liner is suitable for use as a package container.

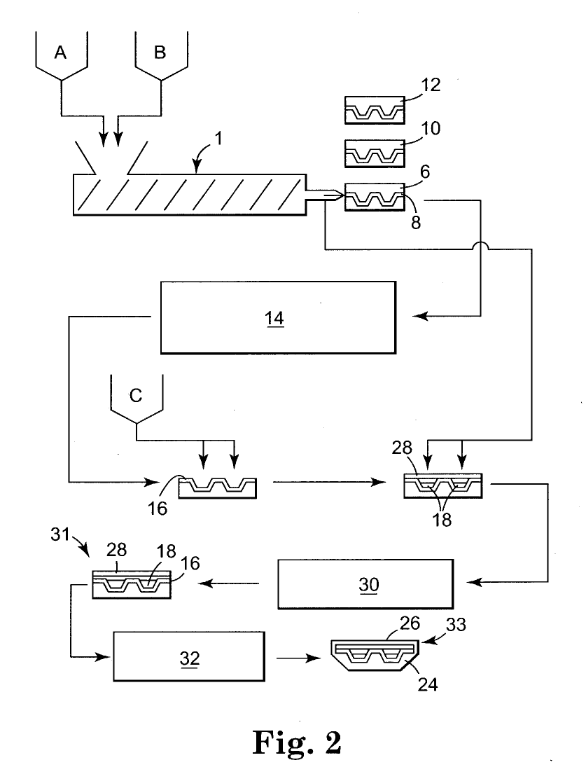

FIG. 2 shows a process similar to the process of FIG. 1, except that after filling 18 is deposited on baked dough portion 16, an additional dough piece is provided as a dough cover piece 28. Dough cover piece 28 may optionally be prepared in a separate dough mixing and sheeting operation, but preferably is mixed using the same or similar extrusion process in order to provide texture, flavor and that is similar or the same as that of baked dough portion 16. Dough cover piece 28 is preferably affixed to dough portion 16 so that the dough cover piece 28 does not separate from dough portion 16 until consumed. Preferably, dough cover piece is positioned so that it, in combination with dough portion 16, and provides no passage for flow of filling 18 outside of the combined dough product. The filled and covered dough product is then conveyed to second oven 30 for baking of dough cover piece 28. Optionally and alternatively, filling 18 could be deposited in an unbaked shaped dough portion 16, dough cover piece 28 affixed thereto (i.e. without passing through oven 14), and the entire combination product cooked at one time in a single pass through oven 30. Joining dough cover piece 28 to dough portion 16 prior to baking may facilitate adhesion of these portions to each other. Techniques of enhancing the adhesion of one dough piece to another may be used as known in the art, such as moistening the surfaces of the dough prior to joining the separate pieces. Baked product 31 is then conveyed to packager 32, where mold 6 is replaced by package container 24 and package lid 26. Alternative techniques for providing a filling are additionally contemplated, such as by coextrusion of the dough and the filling into the mold. In a process utilizing a coextrusion technique, the relative amount of filling and dough may be adjusted by the relative speed of the extruder screw and the flow rate of the filling. An apparatus preferably is provided to secure both ends of the product to seal the filling within the dough product, for example by crimping.

FIG. 3 shows a top view of a filled dough product 40, which is an embodiment of the present invention. Individual recesses 42 are shown in phantom, wherein portions of filling may be located. Surprisingly, the present process allows manufacture of bread products having high filling ratios. This unexpectedly high filling ratio is possible due to the structural stability of bread products, as compared to batter based products that are weaker in structure and tend to structurally fail during handling and consumption by the end user. Preferred embodiments of the present invention have a filling ranging from 10 to 200% of the total weight after baking of the bread product. Score lines or lines of weakness 44 are provided to facilitate separation of individual recesses 42 one from another to provide smaller portions for consumption.

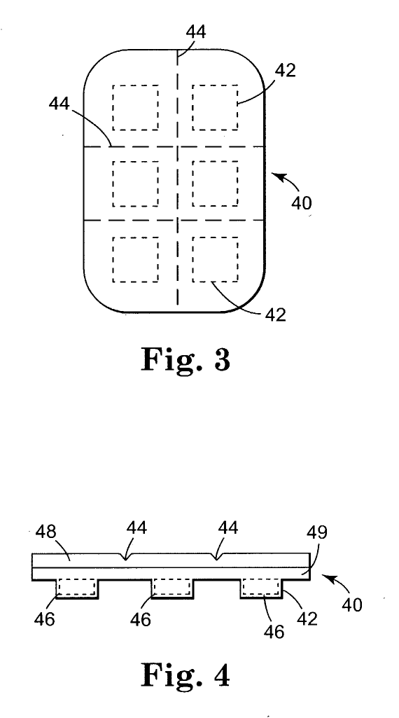

FIG. 4 shows a side view of the filled dough product 40 as shown in FIG. 3. Individual recesses 42 contain filling 46 (shown in phantom). Recesses 42 are sealed by dough cover piece 48, which is applied over the top of a plurality of recesses 42 as a single piece. Lines of weakness 44 are shown as an indentation in dough cover piece 48, which creates a structural weakness at that point of the product to facilitate separation of recesses 42 from each other. Optionally, lines of weakness may instead or additionally be provided at corresponding locations in main body 49 of the filled dough product.

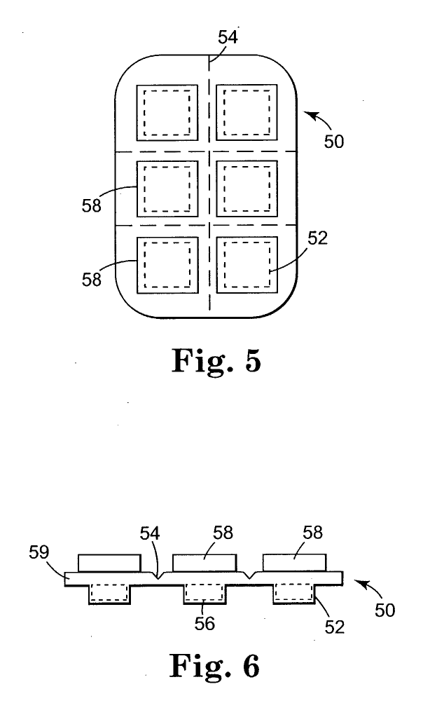

FIG. 5 shows a top view of a filled dough product 50, which is an embodiment of the present invention. Individual recesses 52 are shown in phantom, wherein portions of filling may be located. Score lines or lines of weakness 54 are provided to facilitate separation of individual recesses 52 one from another to provide smaller portions for consumption.

FIG. 6 shows a side view of the filled dough product 50 as shown in FIG. 5. Individual recesses 52 contain filling 56 (shown in phantom). Recesses 52 are sealed by a plurality of dough cover pieces 58, which are applied over the top of each of a plurality of recesses 5 as separate pieces. Lines of weakness 54 are shown as an indentation in the main body 59 of the filled dough product, which creates a structural weakness at that point of the product to facilitate separation of recesses 52 from each other.

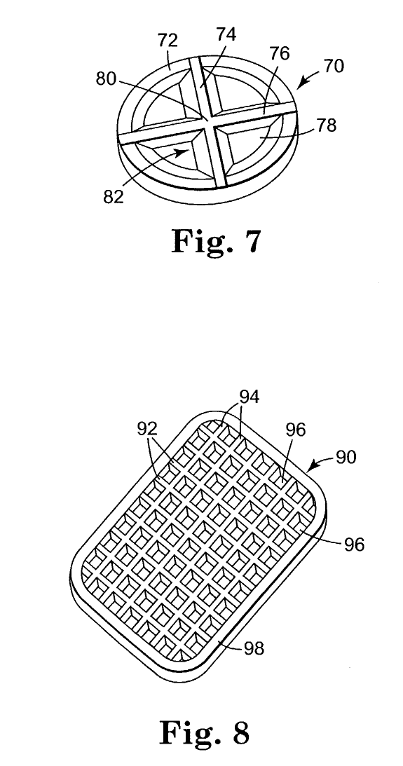

FIG. 7 is a perspective view of a dough product 70, which is an embodiment of the present invention. Outer rim 72 encircles the circumference of the product, with ridges 74 and 76 rising from the floor 78 of the dough product 70 and intersecting generally at the center 80 of dough product 70, thereby forming a plurality of recesses 82 for optionally receiving a filling. The dough product thus provides a complex and multi-surfaced baked product, wherein dough extends to all areas of the product so that the product does not contain visible discontinuous surfaces relative to the intended structure. Optionally, a cover piece of dough may be provided over the top of dough product 70 after filling the recesses 82, thereby providing a contained filled baked bread dough product.

A further embodiment of the present invention is also depicted in FIG. 7. The base or floor 78 of the dough product has a first wall 79 extending about the periphery of the base and connected the base 78 along its bottom edge 77. The wall 79 extends substantially perpendicularly upward from the base or floor 78. The shaped dough product is further provided with at least one longitudinally extending wall or ridge 81 and at least one transversely extending wall or ridge 83. Each of walls or ridges 81 and 83 extend substantially perpendicularly from the base or floor 78. The walls or ridges 79, 81 and 83 intersect one another to form recesses or cavities 82 within the shaped dough product.

FIG. 8 is a perspective view of a dough product 90, which is an embodiment of the present invention having a highly complex shape. Thus a series of orthogonally positioned ridges 92 and 94 are located on the dough product 90, providing a plurality of recesses 96 suitable for optionally receiving a filling. Preferably, an outer ridge 98 encircles the perimeter of the dough product 90, thereby providing an outer boundary that provides functional containment of any filling that is optionally supplied to the dough product 90, and additionally provides a pleasing and finished appearance to the dough product 90. The general appearance of dough product 90 may optionally resemble a waffle. However, unlike a waffle that is made from a batter, the dough product of the present invention has a bread-like consistency that is unexpected in a food of this general construction.

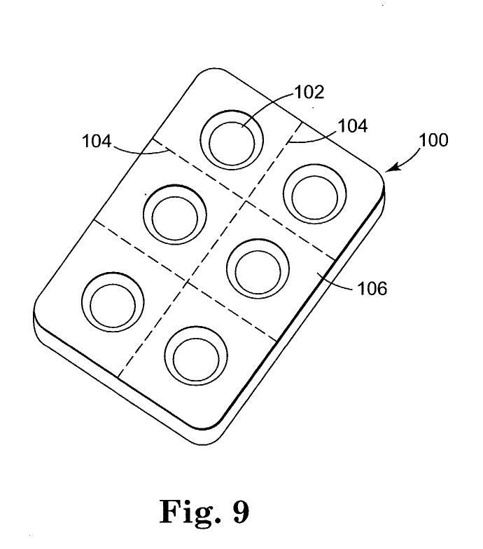

FIG. 9 is a perspective view of a dough product 100, which is an embodiment of the present invention, wherein recesses 102 are provided having a cylindrical or cup-like shape. Optional lines of weakness 104 may be provided in the main body 106 of dough product 100, thereby facilitating separation of recesses 102 from each other. Recesses 102 may optionally be filled with filling, either before or after separation from each other. Each recess may optionally be filled with the same or different filling. In a preferred embodiment of the present invention, different fillings that are complementary in flavor may be placed in proximate recesses for a unique organoleptic experience. Additionally, filling may be selectively placed in only certain recesses, and/or fillings of different appearance (such as color) may be placed in recesses in a predetermined manner to provide a decorative appearance. It will be appreciated that recesses may be provided in any desired shape, including cubic, circular, pyramidal and the like, with the two dimensional bases of the three dimensional volume being any desired geometry, such as square, rectangular, or polygonal (and particularly preferably hexagonal or octagonal), circular, oval, and so forth.

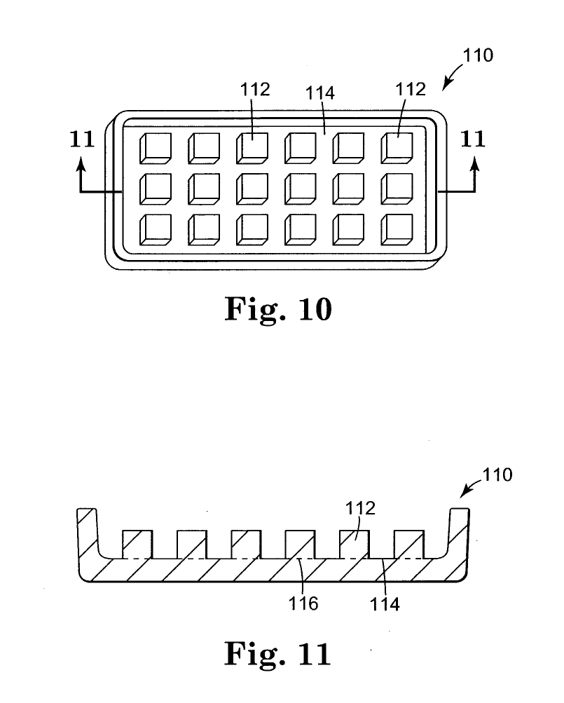

FIG. 10 is a perspective view of a dough product 110, which is an embodiment of the present invention, wherein projections 112 project from the floor 114 of dough product 110. It will be appreciated that projections 112 may be provided in any desired shape, including cubic, circular, pyramidal and the like, with the two dimensional bases of the three dimensional volume being any desired geometry, such as square, rectangular, or polygonal (and particularly preferably hexagonal or octagonal), circular, oval, and so forth.

FIG. 11 is a cross section of the dough product 110 as shown in FIG. 10, taken along line 11-11. The size of projections 112 can be evaluated by drawing an imaginary line 116 across the base of projection 112, extending the floor 114 and thereby defining a cross-sectional area of the projection 112 for measurement. Because of the unique ingredient selection and processing conditions, it is possible to manufacture bread-like dough products in surprisingly complex shapes with reproducible rendition of the shape on a mass production basis. Thus, for example, one can now make a honeycomb shaped dough product with bread-like consistency both economically on a mass scale with reproducible rendition of the desired shape. The cross section of a recess may similarly be evaluated by drawing an imaginary line across the surface of a dough product that is otherwise interrupted with a recess, and determining the cross-sectional area of the recess as bounded by the surface of the product and the imaginary line.

Bread products of the present invention surprisingly may have reproducible complex shapes that have small geometries, either as projections or recesses, in their structure. Thus, for example, relatively small channels (which may be considered an extended recess) or ridges (which may be considered an extended projection) may surprisingly be provided in a mass produced bread-like product as reproducible structures without visible flaws. In a preferred embodiment, the product contains at least one projection or recess that has a cross-sectional area of less than about 4 square centimeters. More preferably, the product contains at least about 4 projections or recesses that each have a cross-sectional area of less than about 4 square centimeters. In a particularly preferred embodiment, the product contains at least one projection or recess that has a cross-sectional area of less than about 1 square centimeter. More preferably, the product contains at least about 4 projections or recesses that each have a cross-sectional area of less than about 1 square centimeter. In a particularly preferred embodiment, the dough product of the present invention preferably comprises a reticulated series of recesses, each recess having a volume of about 64 cubic centimeters or less.

Preferably, the bread product of the present invention has a multi-surfaced complex shape comprising a plurality of surfaces that form a three dimensional pattern corresponding to the shape of a mold into which the bread dough is extruded. As the number of surfaces in the bread product increases, it is generally increasingly difficult to provide an accurate rendition of the product without visible flaw when producing the product in a mass-production system. Preferably, the bread product comprises at least about 10 surfaces, more preferably at least about 18 surfaces. The surfaces may join one another at any angle that serves to define a difference from one surface to another. Generally, the smaller the angle between adjacent surfaces, the more difficult it is to provide an accurate rendition of the product without visible flaw when producing the product in a mass-production system. Particularly preferred complex shapes comprise surfaces that form at least 6 angles that are less than about 160°, more preferably form angles less than about 140°, and yet more preferably form angles less than about 120°. A most preferred embodiment of the present invention comprises a shaped bread product comprises surfaces that form at least 8 angles of about 100° or less.

As noted above, the dough component of the present invention comprises flour, water, and a pre-gelatinized starch comprising at least about 75 percent of amylopectin. These ingredients, as well as additional optional ingredients, will now be discussed in detail.

Flour used in the dough of the present invention may be any suitable flour for manufacture of bread. Appropriate flours for use in the present invention include whole grain flours, flours with the bran and/or germ removed, bleached or unbleached, or combinations thereof. Wheat flour is preferred, although non-wheat flours may be used in conjunction with wheat flours or alone if desired. For example, rye, pumpernickel, and rice flour may alternatively be used in the doughs of the present invention.

Water is a necessary ingredient in doughs of the present invention. Water is added to the dough as liquid water, ice, or it is added via hydrated ingredients. Ice may be added to supply water to doughs in order to keep the combination cool during mixing. Water is preferably present in the dough in the amount up to about 50 percent by weight, and more preferably between about 25 and 45 percent by weight.

The starch component of the dough composition to be used in the present invention is a pregelatinized starch, meaning that the starch is gelatinized prior to adding to the other ingredients of the dough composition. While ungelatinized starch is insoluble in water at 20° C. (68° F.), gelatinized starch is water soluble. Thus, a 5 gram sample of gelatinized starch mixed in 100 ml water has no visible insoluble components.

Ungelatinized starch is gelatinized by heating the starch granules in the presence of water, or alternatively exposing the starch to water together with a catalyst (such as acid) or enzyme, under conditions that disrupt the amorphous regions of the starch granule, and permit hydrogen bonding between starch and water molecules. The granules are then able to absorb water and swell, thereby putting increasingly greater stress on the crystalline regions. Within a certain range of temperatures, the characteristic of each starch suddenly loses all organized structure and becomes an amorphous network of starch and water intermingled. This is called the gelatinization range, because the granules become tiny gels, or liquid-containing meshworks of long molecules. This range is between about 140-148° F. for wheat flour, and between about 144 and 158° F. for corn starch. Both flour and cornstarch are produced from seeds. Other sources of starch exist which include rice starch and root starches such as arrowroot, tapioca, and potato to name a few. These starches tend to gelatinize at lower temperatures than the seed starches. As yet another source for pregelatinized starch, bread made by the same or a different process may be ground up or otherwise prepared for addition to the dough composition of the present invention in an amount sufficient to act as the source for pregelatinized starch.

The pre-gelatinized starch comprises at least about 75 percent amylopectin, more preferably at least about 80 percent, and most preferably at least about 90 percent of amylopectin. It has surprisingly been found that pre-gelatinized starches having the indicated amount of amylopectin exhibit the desired BSV, and that starches that contain less than about 75 percent amylopectin do not exhibit the desired BSV in the final baked bread dough product.

Pre-gelatinized starch is preferably present in the dough composition of the invention in amounts of from about 1 to about 12 percent by weight, and more preferably from about 2 percent to about 7 percent by weight of the total dough composition.

The dough of the present invention additionally may comprise alginate for improved textural properties, or enhance mouthfeel. Preferably, propylene glycol alginate is present in an amount of from about zero to about 0.25% by weight of the total dough composition.

Gluten is preferably present in the present invention to provide the matrix for accommodating the leavening gas and allowing the food product of the present invention to raise. When the flour that is used in the product of the present invention is wheat, gluten is naturally provided in the wheat flour, and no additional gluten need be added to the composition. Other flours may alternatively be used, with the addition of gluten as required so that the end food product may be leavened. It will be appreciated that a highly preferred embodiment of the present invention therefore utilizes wheat flour, because the gluten is automatically included in the food product of the present invention at very low cost and without additional processing steps.

The dough is provided with the desired gas cell structure in the final product to achieve the desired BSV through techniques generally known in the art. Preferably, carbon dioxide gas or other suitable gas is injected into the dough composition during the extrusion process as a mechanical leavening process. In a preferred embodiment, air or nitrogen, or more preferably a combination of air and nitrogen, is injected into the dough during the extrusion process in an amount effective to achieve the desired BSV of the final product. U.S. Pat. No. 6,042,852 describes a system that may be utilized to provide injection of gas for the purpose of leavening the bread product of the present invention.

Alternatively or in addition to the gas injection process described above, a leavening agent can be added to the dough to provide the desired production of carbon dioxide to leaven the dough. The leavening agent may be either yeast or a chemical leavening system, or a combination of the two.

For purposes of the present invention, a chemical leavening system is a combination of chemical ingredients that react to produce carbon dioxide. Preferably, these chemical ingredients are a combination of an acid and a base that react to release carbon dioxide into the dough and thereby increase the volume of the dough. Suitable leavening acids are generally known in the industry and include but are not limited to citric acid, sodium acid pyrophosphate (SAPP), sodium aluminum phosphate (SALP), monocalcium phosphate (MCP), dicalcium phosphate (DCP), sodium aluminum sulfate (SAS), anhydrous monocalcium phosphate (AMCP), dimagnesium phosphate (DMP), dicalcium phosphate dihydrate (DCPD), gluconodelta lactone (GDL) and mixtures thereof. Suitable bases used in leavening agents generally include a carbonate and/or a bicarbonate salt. Suitable carbonate and bicarbonate salts include, for example, sodium carbonate, potassium carbonate, sodium bicarbonate (commonly known as baking soda), potassium bicarbonate, ammonium bicarbonate and mixtures thereof. An example of a preferred chemical leavening system is the combination of sodium bicarbonate and a combination of SAPP and SALP leavening acids.

Yeast may be used either alone or in conjunction with a chemical leavening system to leaven the dough of the present invention. Yeast provides particular flavor and textural benefits, even when not acting as the primary leavening system for the bread product. Any suitable yeast and format thereof may be utilized, including baker's yeast, activated yeast, crumbled yeast, and so forth. When yeast is used as the sole or primary leavening agent in the dough of the present invention, time for proofing the dough may be required after extrusion and before cooking of the raw dough product to obtain the desired baked specific volume. The time required for proofing depends on the composition of the dough, and may be readily determined by the practitioner.

When the leavening agent is used is yeast or a chemical leavening system, the leavening agent preferably is provided as about 1% to about 6% by weight of the dough.

The dough may optionally include fat. Possible fat ingredients include, for example, oils and shortenings. Suitable oils include, for example, soybean oil, corn oil, canola oil, olive oil, sunflower oil, peanut oil, and other vegetable or nut oils. Suitable shortenings include, for example, animal fats such as butter and hydrogenated vegetable oils such as margarine. In preferred embodiments, the dough includes no more than about 10 percent by weight of fat and more preferably from about 0.5 percent by weight to about 6 percent by weight of fat. In other preferred embodiment, such as biscuits, fat may be present in amounts up to about 20 percent by weight. Typically, fats provided in excess of about 10 percent are added in the solid chip form. Fats play a role in both the texture and flavor of the dough product. Depending upon the amount of fat included in the dough composition, the fat may interfere with the gluten structure altering the texture of the dough. Generally, more fatty doughs result in weaker gluten structures producing softer dough products. Additionally, the fat can act as a flavoring agent providing a richer tasting dough. Fats also have a tenderizing effect on bread-like products due to the fact that the lipids act to slow loss of moisture by coating the starch granules. While not being bound by theory, it is further believed that fats may act as a lubricant to enhance extrudability of the dough composition through the extrusion process.

The dough can also include a sweetener, which may be provided either as a natural or artificial sweetener or as a liquid or dry ingredient. Suitable sweeteners include but are not limited to lactose, sucrose, fructose, dextrose, maltose, corresponding sugar alcohols, corn syrup, malt and hydrolyzed corn syrup, maltodextrin, and mixtures thereof. Such sweeteners may act either or both as flavoring agents, texturizing, or browning agents. Sugar can also affect the development of the gluten, because sugar is hygroscopic and competes with the flour proteins for the available water. For this reason, high-sugar doughs tend to take longer to form and to develop. This same characteristic causes the final product to be moister, more tender, and to stay moist and tender longer, since moisture leaves the bread less readily when sugar is there to absorb it. Finally, added sugar enhances browning reactions and will make for a darker crust in a given period of baking.

The dough composition may optionally include additional flavoring agents. Such flavoring agents include but are not limited to such ingredients as salt, milk and milk products, eggs and egg products, cocoa, whey, malt, yeast, yeast extract, inactivated yeast, spices, herbs, vanilla, and commercially available flavorants, such as butter flavor. The optional flavoring agent preferably is present as greater than about 0.1 percent by weight of the dough, and more preferably is from about 0.5 and about 5.0 percent by weight of the dough.

Besides flavoring agents, the dough can further include preservatives, emulsifiers and hydrocolloids. Suitable emulsifiers include, for example, mono- and di-glycerides of fatty acids, propylene glycol mono- and di-esters of fatty acids, glycerol-lacto esters of fatty acids, ethoxylated mono-glycerides, lecithin, protein, and mixtures thereof. Preferred emulsifiers include mono-glycerides and mixtures of propylene glycol mono- and di-esters of fatty acids, mono-glycerides and lecithin. Suitable hydrocolloids assist in building viscosity, binding water, and trapping gases, which include, for example, starches, gums (e.g. xanthan and guar), cellulose, and carageenan. Preservatives, emulsifiers, and hydrocolloids combined comprise preferably less than about 5 percent by weight of the dough, and each preferably between about 0.1 percent and about 2.5 percent by weight of the dough. Suitable preservatives provide shelf-life extension for the baked product, and include, for example, potassium sorbate, sorbic acid, sodium propionate, and sodium diacetate.

Preferred dough compositions used in the method of the present invention comprise ingredients in the following amounts:

| | |
|---|---|
| pregelatinized starch | 2-7% |
| flour | 55-65% |
| yeast or chemical leavening agent | 1-6% |
| water | 28-40%. |

The filling to be used in one aspect of the present invention may be any filling appropriate for consumption together with a bread. The filling may incorporate any type of sweet or savory filling ingredients suitable for the desired organoleptic experience of the particular food product. Examples of savory ingredients include but are not limited to meat, vegetable, and dairy ingredients (including flavored butter components). As one example, a particularly desired food product may be positioned as a breakfast food, and would comprise filling ingredients such as eggs, bacon, and cheese. Another desired food product may be a fruit product, which would comprise fruit fillings such as cherries, strawberries, blueberries, blackberries, bananas, apples, peaches and the like. Yet another desired food product may be a sweet food product comprising fillings such as fruits, custards, chocolates, icing, honey and any number of other common pie-type fillings. Food products intended for use as entree or side dish uses may preferably comprise meat fillings including chicken, turkey, beef, and the like and/or vegetables such as corn, carrots, spinach, beans, peas, green peppers and the like. Particularly preferred savory fillings comprise cheese fillings, tomato paste sauces such as Italian sauces, and meat flavored gravies. One class of particularly preferred filling comprises ingredients typically contained in pizza, including tomato based sauces, cheese, certain vegetables and meats, with pepperoni and sausage meats most preferred. Another class of a preferred filling is a combination of meat, and particularly hamburger, in combination with a tomato based sauce, commonly known as “sloppy joe's.”

Both savory and sweet ingredients may further include spices, herbs, flavoring agents, fats, and the like. The filling may further include such ingredients as preservatives and consistency modifiers such as emulsifiers and thickening agents.

Other additives that may optionally be utilized in the fillings of the present invention include, for example: salt; whiteners, such as titanium dioxide; anti-microbial agents, such as potassium sorbate, sorbic acid, dehydroacetic acid, sodium benzoate, and the like; buffers; food acids; preservatives; antioxidants, such as butylated hydroxytoluene, butylated hydroxyanisole, and the like; as well as vitamins and minerals.

After being baked, the dough product is packaged for delivery to commercial users of the product, such as restaurants, cafeterias and the like, or for delivery to retail outlets such as grocery stores for subsequent purchase by the home consumer. The dough product is preferably packaged in a manner suited for the particular customer and their projected use. Thus, commercial establishments may prefer to obtain dough products of the present invention in bulk form, while the home consumer may prefer to obtain single product or packaging containing small numbers of product. In a preferred embodiment, the product is provided in a resealable package. In a particularly preferred embodiment, the product of the present invention is provided in packaging appropriate for placement in microwave ovens, and most preferably comprising a microwave susceptor to assist in heating of the product in a microwave oven. The dough product of the present invention may be provided as a refrigerated product, or more preferably may be provided in the frozen state. For purposes of the present invention, the term “frozen” describes dough products that are maintained at a temperature below the freezing point of water, regardless of whether all ingredients in the dough product are actually in the frozen state.

In a still further embodiment of the present invention, the bread product may be distributed as a fresh bread product available for immediate use without thawing but may still be consumed in a heated or warmed condition.

Certain embodiments of the present invention are preferably heated prior to consumption. Preferably the products are designed for heating in any manner by the consumer. While such products may be prepared by heating in a conventional oven, convenience is further provided if the product is capable of being heated by a microwave oven. Products that are intended to be heated by specialized techniques, such as by a grill or deep fryer, are also contemplated.

All percentages and ratios used herein are weight percentages and ratios unless otherwise indicated. The invention will further be illustrated by the following non-limiting examples:

All publications, patents and patent documents cited are fully incorporated by reference herein, as though individually incorporated by reference. Numerous characteristics and advantages of the invention meant to be described by this document have been set forth in the foregoing description. It is to be understood, however, that while particular forms or embodiments of the invention have been illustrated, various modifications, including modifications to shape, and arrangement of parts, and the like, can be made without departing from the spirit and scope of the invention.

1. A process for forming shaped bread dough products, comprising
a) providing a dough composition comprising flour, water, and a pre-gelatinized starch comprising at least about 75 percent of amylopectin;
b) mixing the dough composition and extruding the dough under conditions so that the dough composition does not exceed 140° F. throughout the extrusion process, said doughhaving an extensibility ranging from about 170 to about 240 mm;
c) extruding the mixed dough, into a shaped mold, thereby imparting a shape to the dough corresponding to the shape of the mold; and
d) baking the dough so that the baked shaped dough product has a bread-like texture and a BSV of greater than about 2.5 cc/g.

2. The process of claim 1, wherein the shaped bread dough product is formed into a shape comprising a plurality of recesses and/or projections.

3. The process of claim 2, wherein the shaped bread dough product additionally comprises a filling.

4. The process of claim 3, wherein the shaped bread dough product comprises a cover piece over said filling.

5. The process of claim 4, wherein the filling is encased within shaped bread dough product.

6. The process of claim 3, wherein the shaped bread dough product has a filling ranging between 10% to 200% of the shaped bread dough product after baking

7. The process of claim 1, wherein the shaped bread dough product contains at least one projection or recess that has a cross-sectional area of less than about 4 square centimeters.

8. The process of claim 1, wherein the shaped bread dough product contains at least one projection or recess that has a cross-sectional area of less than about 1 square centimeter.

9. The process of claim 1, wherein the shaped bread dough product comprises at least about 10 surfaces.

10. The process of claim 1, including a further step injecting nitrogen into the mixed dough prior to the step of extruding the dough.

11. The process of claim 1, wherein the shaped bread dough product comprises a reticulated series of recesses, each recess having a volume of about 64 cubic centimeters or less.

12. A shaped bread dough product made by the process of claim 1.

13. Shaped bread dough products having a precision reproducible shape comprising flat and/or curvilinear surfaces corresponding to the shape of a mold, wherein all exposed surfaces of two such bread products are the same in dimension and without visible flaw, said shaped bread dough products having a bread-like texture and a BSV of greater than about 2.5 cc/g and being uniform in density.

14. The bread product of claim 13, wherein the shaped bread dough product additionally comprises a filling.

15. The bread product of claim 14, wherein the shaped bread dough product has a filling ranging between 10% to 200% of the shaped bread dough product after baking.

16. Shaped bread dough products having a precision reproducible shape comprising flat and/or curvilinear surfaces corresponding to the shape of a mold, wherein all exposed surfaces of two such bread products are the same in dimension and without visible flaw, said shaped bread dough products having a bread-like texture and a BSV of greater than about 2.5 cc/g, wherein the shaped bread dough product contains at least one projection or recess that has a cross-sectional area of less than about 4 square centimeters.

17. The bread product of claim 16, wherein the shaped bread dough product contains at least one projection or recess that has a cross-sectional area of less than about 1 square centimeter.

18. Shaped bread dough products having a precision reproducible shape comprising flat and/or curvilinear surfaces corresponding to the shape of a mold, wherein all exposed surfaces of two such bread products are the same in dimension and without visible flaw, said shaped bread dough products having a bread-like texture and a BSV of greater than about 2.5 cc/g, wherein the shaped bread dough product comprises at least about 10 surfaces.

19. The bread product of claim 18, wherein the shaped bread dough product comprises surfaces that form at least 6 angles that are less than about 160°.

20. Shaped bread dough products having a precision reproducible shape comprising flat and/or curvilinear surfaces corresponding to the shape of a mold, wherein all exposed surfaces of two such bread products are the same in dimension and without visible flaw, said shaped bread dough products having a bread-like texture and a BSV of greater than about 2.5 cc/g, wherein the shaped bread dough product comprises a reticulated series of recesses, each recess having a volume of about 64 cubic centimeters or less.

21. A molded, shaped dough product having a bread like texture, comprising;
a base having an interior area and an exterior periphery and at least one wall extending substantially perpendicularly from said base and being positioned about said periphery, said at least one wall having have a height and a thickness;
a plurality of cavities, each of said cavities formed from at least an intersection of at least one longitudinally extending ridge and at least one transversely extending ridge with said at least one wall, each of said transversely and longitudinally extending ridges extending substantially perpendicularly from said base and each of said plurality of cavities being capable of receiving a filling;
each of said transversely extending and longitudinally extending ridges having a top and bottom edge with said bottom edge of each wall being connected to said base;
said longitudinally extending ridge and said transversely extending ridge have a height substantially equal to said height of said at least one wall extending about the periphery of the base; and
the molded shaped dough product as an extensibility of between 170 to 240 mm.

22. A molded, shaped dough product as recited in claim 21, wherein each of said transversely extending ridge and said longitudinally extending ridge have a thickness substantially equal to said at least one wall extending about the periphery of the base.

23. A molded, shaped dough product as recited in claim 21, wherein said top edge of said transversely extending ridge and said longitudinally extending ridge is tapered.

24. A molded, shaped dough product as recited in claim 21, wherein said shaped dough product may be provided in a fresh, refrigerated, frozen condition or combinations thereof.
